(19) United States
(12) Patent Application Publication
(10) Pub. No.: US 2016/0027381 A1
(43) Pub. Date: Jan. 28, 2016

(54) ORGANIC LIGHT-EMITTING DIODE DISPLAY AND METHOD OF DRIVING THE SAME

(71) Applicant: Samsung Display Co., Ltd., Yongin-City (KR)

(72) Inventors: Do-Hyung Ryu, Yongin-si (KR); Jae-Woo Song, Anyang-si (KR); Jae-Hoon Lee, Seoul (KR); Hae-Goo Jung, Seongnam-si (KR)

(21) Appl. No.: 14/586,533

(22) Filed: Dec. 30, 2014

(30) Foreign Application Priority Data
Jul. 28, 2014 (KR) 10-2014-0095587

(51) Int. Cl. G09G 3/32

(52) U.S. Cl. CPC G09G 3/3291; G09G 3/3283; G09G 3/3266; G09G 2360/08; G09G 2330/08

(57) ABSTRACT

An organic light-emitting diode (OLED) display and a method of driving the same are disclosed. In one aspect, the method includes displaying an image on a display panel based at least in part on a first power voltage provided through a first power line and a second power voltage having a first voltage level provided through a second power line. The display panel is configured to receive the first and second power voltages from a power supply unit. The method also includes providing the second power voltage having a second voltage level higher than the first voltage level to the display panel through the second power line, detecting a second power line current flowing through the second power line when the second power voltage has the second voltage level, and turning off the power supply unit when the second power line current is detected.

### CROSS-REFERENCE TO RELATED APPLICATIONS

This application claims priority from and the benefit of Korean Patent Applications No. 10-2014-0095587, filed on Jul. 28, 2014 in the Korean Intellectual Property Office (KIPO), the disclosure of which is hereby incorporated by reference herein in its entirety.

### BACKGROUND

1. Field

The described technology generally relates to organic light-emitting diode displays and methods of driving the same.

2. Description of the Related Technology

An organic light-emitting diode (OLED) display uses OLEDs that emit light by recombining electrons and holes. The displays have a wide viewing angle, rapid response, a thin profile and low power consumption.

The OLED display can be driven by an analog driving technique or by a digital driving technique.

The OLED display driven by the digital driving technique includes a plurality of pixel circuits each having a simple pixel circuit with two switching transistors and a storage capacitor. Thus, this OLED display is used for large-area display devices.

### SUMMARY OF CERTAIN INVENTIVE ASPECTS

One inventive aspect is an OLED display that detects abnormal operation of a display panel by controlling a second power voltage.

Another aspect is a method of driving the OLED display.

Another aspect is an OLED display driven by a digital driving technique that can comprise a display panel including a plurality of pixels, a scan driver configured to provide a scan signal to the display panel through a scan line, a data driver configured to provide a data signal to the display panel through a data line, the data signal having one of a first logic level and a second logic level, a power supply unit configured to provide a first power voltage and a second power voltage through a first power line and a second power line, respectively, to provide the second power voltage having a first voltage level to the display panel during an emission period such that the pixels emit light, and to provide the second power voltage having a second voltage level higher than the first voltage level to the display panel during a non-emission period such that the pixels do not emit light, a first sensing unit configured to detect a second power line current flowing through the second power line during the non-emission period, a power controller configured to determine the non emission period, and to turn off the power supply unit based on a current detection signal outputted from the first sensing unit, and a timing controller configured to control the scan driver, the data driver, the power supply unit and the power controller. The non-emission period is generated when an abnormal operation of the display panel is detected, or periodically generated.

In example embodiments, the OLED display further comprises a second sensing unit configured to detect a voltage applied to the first power line or the second power line in the emission period.

In example embodiments, the second sensing unit is configured to compare the detected voltage with a predetermined reference voltage range, and to output an abnormal detection signal when the detected voltage deviates from the reference voltage range.

In example embodiments, the power controller is configured to control the power supply unit to output the second power voltage having the second voltage level during a predetermined duration in response to the abnormal detection signal.

In example embodiments, the first sensing unit is configured to detect the second power line current during the predetermined duration.

In example embodiments, the power controller is configured to generate a defect signal, and to provide the defect signal to the timing controller when the second power line current is not detected.

In example embodiments, the timing controller is configured to generate an image data signal having a failure occurrence message information in response to the defect signal. The display panel can be configured to display a failure occurrence message based on the image data signal.

In example embodiments, the OLED display further comprises a second sensing unit configured to detect a current applied to the first power line or the second power line in the emission period.

In example embodiments, the second sensing unit is configured to compare the detected current with a predetermined reference current range, and to output an abnormal detection signal when the detected current deviates from the reference current range.

In example embodiments, the power controller is configured to control the power supply unit to output the second power voltage having the second voltage level during a predetermined duration in response to the abnormal detection signal.

In example embodiments, the first sensing unit is configured to detect the second power line current during the predetermined duration.

In example embodiments, the power controller is configured to generate a defect signal, and to provide the defect signal to the timing controller when the second power line current is not detected.

In example embodiments, the timing controller is configured to generate an image data signal having a failure occurrence message information in response to the defect signal. The display panel can be configured to display a failure occurrence message based on the image data signal.

In example embodiments, the power controller is configured to control the power supply unit to output the second power voltage having the second voltage level during a predetermined duration and output the second power voltage having the first voltage level after the predetermined duration when a display mode is changed.

In example embodiments, the first sensing unit is configured to detect the second power line current during the predetermined duration

Another aspect is a method of driving an OLED display that can comprise displaying an image on a display panel based on a first power voltage provided through a first power line, and a second power voltage having a first voltage level provided through a second power line, a scan signal, and a data signal, the second power voltage having a first voltage level, providing the second power voltage having a second voltage level higher than the first voltage level to the display panel through the second power line, detecting a second power line current flowing through the second power line when the second power voltage has the second voltage level, and turning off a power supply unit providing the first power voltage and the second power voltage to the display panel when the second power line current is detected.

In example embodiments, providing the second power voltage having the second voltage level includes detecting a voltage applied to the first power line or the second power line, comparing the detected voltage with a predetermined reference voltage range, and providing the second power voltage having the second voltage level to the display panel when the detected voltage deviates from the reference voltage range.

In example embodiments, the method further comprises outputting a defect signal when the detected voltage deviates from the reference voltage range but the second power line current is not detected, and displaying a failure occurrence message on the display panel based on the defect signal.

In example embodiments, the second voltage level of the second power voltage is substantially periodically provided to the display panel through the second power line.

In example embodiments, the method further comprises providing the second power voltage having the second voltage level to the display panel in a predetermined duration when a display mode is changed.

Another aspect is an organic light-emitting diode (OLED) display driven by a digital driving technique. The OLED display comprises a display panel including a plurality of pixels, a scan driver configured to provide a scan signal to the display panel through a scan line, and a data driver configured to provide a data signal to the display panel through a data line, wherein the data signal has one of first and second logic levels. The OLED display also comprises a power supply unit configured to provide first and second power voltages respectively through first and second power lines so as to i) transmit the second power voltage having a first voltage level to the display panel during an emission period such that the pixels emit light and ii) transmit the second power voltage having a second voltage level higher than the first voltage level to the display panel during a non-emission period such that the pixels do not emit light. The OLED further comprises a first sensor configured to detect a second power line current flowing through the second power line during the non-emission period and a power controller configured to determine the non-emission period and turn off the power supply unit based at least in part on a current detection signal output from the first sensor. The OLED further comprises a timing controller configured to control the scan driver, the data driver, the power supply unit and the power controller, wherein the non-emission period is substantially periodic or corresponds to when an abnormal operation of the display panel is detected.

The above device further comprises a second sensor configured to detect a voltage applied to the first power line or the second power line during the emission period.

In the above device, the second sensor is further configured to i) determine whether the detected voltage is within a predetermined reference voltage range and ii) output an abnormal detection signal when the detected voltage is not within the reference voltage range.

In the above device, the power controller is further configured to control the power supply unit so as to output the second power voltage having the second voltage level during a predetermined duration based at least in part on the abnormal detection signal.

In the above device, the first sensor is further configured to detect the second power line current during the predetermined duration.

In the above device, the power controller is further configured to i) generate a defect signal and ii) provide the defect signal to the timing controller when the second power line current is not detected.

In the above device, the timing controller is further configured to generate an image data signal having failure occurrence message information based at least in part on the defect signal, wherein the display panel is configured to display a failure occurrence message based at least in part on the image data signal.

The above device further comprises a second sensor configured to detect a current applied to the first or second power line during the emission period.

In the above device, the second sensor is further configured to i) determine whether the detected current is within a predetermined reference current range and ii) output an abnormal detection signal when the detected current is not within the reference current range.

In the above device, the power controller is further configured to control the power supply unit so as to output the second power voltage having the second voltage level during a predetermined duration based at least in part on the abnormal detection signal.

In the above device, the first sensor is further configured to detect the second power line current during the predetermined duration.

In the above device, the power controller is further configured to i) generate a defect signal and ii) provide the defect signal to the timing controller when the second power line current is not detected.

In the above device, the timing controller is further configured to generate an image data signal having failure occurrence message information based at least in part on the defect signal, wherein the display panel is configured to display a failure occurrence message based at least in part on the image data signal.

In the above device, the power controller is further configured to control the power supply unit to i) output the second power voltage having the second voltage level during a predetermined duration and ii) output the second power voltage having the first voltage level after the predetermined duration when a display mode is changed.

In the above device, the first sensor is further configured to detect the second power line current during the predetermined duration.

Another aspect is a method of driving an organic light-emitting diode (OLED) display by a digital driving technique. The method comprises displaying an image on a display panel based at least in part on i) a first power voltage provided through a first power line and ii) a second power voltage having a first voltage level provided through a second power line, wherein the display panel is configured to receive the first and second power voltages from a power supply unit. The method also includes providing the second power voltage having a second voltage level higher than the first voltage level to the display panel through the second power line. The method also includes detecting a second power line current flowing through the second power line when the second power voltage has the second voltage level. The method also includes turning off the power supply unit when the second power line current is detected.

In the above method, the providing includes detecting a voltage applied to the first or second power line, determining whether the detected voltage is within a predetermined reference voltage range, and providing the second power voltage having the second voltage level to the display panel when the detected voltage is not within the reference voltage range.

The above method further comprises outputting a defect signal when the detected voltage is not within the reference voltage range and the second power line current is not detected. The above method further comprises displaying a failure occurrence message on the display panel based at least in part on the defect signal.

In the above method, the second voltage level of the second power voltage is substantially periodically provided to the display panel through the second power line.

The above method further comprises providing the second power voltage having the second voltage level to the display panel during a predetermined duration when a display mode is changed.

According to at least one of the disclosed embodiments, the OLED display can detect abnormal operations of the display panel by switching (swinging) the voltage level of the second power voltage ELVSS substantially periodically or non-periodically, and turning off the power supply unit when an abnormal operation is detected. Further, the OLED display can display the failure occurrence message when an abnormal operation of the display panel is detected. Thus, overheating of the display panel and burning out of an internal element of the display panel caused by overcurrent, etc, can be prevented, and incorrect operations of the display panel can be decreased. Further, it is possible to prevent additional damage from being caused by overheating, such as a fire.

In addition, when the display mode is changed, the OLED display swings the voltage level of the second power voltage ELVSS so that display noise from the garbage data can be prevented.

In addition, the method of driving the OLED display can detect abnormal operations of the display panel by switching (swinging) the voltage level of the second power voltage ELVSS substantially periodically and non-periodically. The method can turn off the power supply unit or display the failure occurrence message when an abnormal operation of the display panel is detected. Thus, overheating of the display panel and burning out of an internal element of the display panel can be prevented. In addition, it is possible to prevent additional damage from being caused by overheating, such as a fire.

### BRIEF DESCRIPTION OF THE DRAWINGS

FIG. 1 is a block diagram of an OLED display according to example embodiments.

FIG. 2 is a circuit diagram illustrating an example of a pixel included in the OLED display of FIG. 1.

FIG. 3A is a block diagram illustrating an example of controlling a power supply unit included in the OLED display of FIG. 1.

FIG. 3B is a timing diagram illustrating an example of control operation the power supply unit of FIG. 3A.

FIG. 4A is a block diagram illustrating another example of controlling a power supply unit included in the OLED display of FIG. 1.

FIG. 4B is a timing diagram illustrating an example of control operation a power controller of FIG. 4A.

FIG. 4C is a diagram illustrating an example of a display panel displaying a message by operation of the power controller of FIG. 4A.

FIG. 5 is a timing diagram illustrating still another example of controlling a power supply unit included in the OLED display of FIG. 1.

FIG. 6 is a flowchart of a method of driving an OLED display according to example embodiments.

FIG. 7 is a flowchart illustrating an example of operation of the OLED display of FIG. 6 that detects abnormal operations.

FIG. 8 is a flowchart illustrating an example of operation of the OLED display of FIG. 6 when a display mode is converted.

### DETAILED DESCRIPTION OF CERTAIN INVENTIVE EMBODIMENTS

In an analog OLED display driving technique, detecting abnormal current of a display panel is performed during a non-emission period. The technique uses an emission control signal having an inactivate level provided to a pixel circuit through an emission control line. In a digital driving technique, the emission control signal and the emission control line do not exist (i.e., the non-emission period does not exist), and therefore, the OLED display cannot detect the abnormal current of a display panel in the same way as the analog driving technique. Therefore, the digitally driven display is vulnerable to overheating and a burn out of pixels caused by abnormal current.

Exemplary embodiments will be described more fully hereinafter with reference to the accompanying drawings, in which various embodiments are shown. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

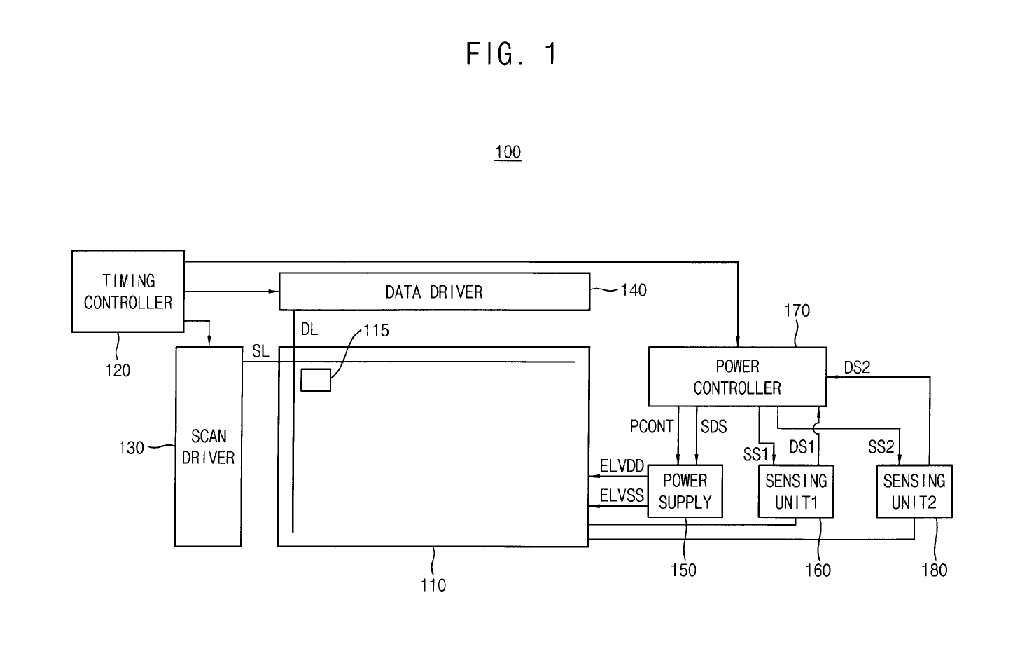

FIG. 1 is a block diagram of an OLED display according to example embodiments.

Referring to FIG. 1, the OLED display 100 includes a timing controller 120, a scan driver 130, a data driver 140, a power supply unit 150, a first sensing unit (or a first sensor) 160, and a power controller 170. The OLED display 100 can further include a second sensing unit (or a second sensor) 180.

The OLED display 100 can be driven by a digital driving technique. That is, the OLED display 100 displays a gray scale by controlling a light emitting duration of each of the plurality of pixels 115 based at least in part on a logic level of the data signal applied from the data driver 140.

The display panel 110 displays an image. The display panel 110 can include a plurality of scan lines SL, a plurality of data lines DL, and a plurality of pixels 115 that are electrically connected to the scan lines SL and the data lines DL and arranged in a matrix form.

The timing controller 120 can control the scan driver 130, the data driver 140, the power supply unit 150, the first sensing unit 160, the power controller 170, and the second sensing unit 180. The timing controller 120 can receive an input control signal and an input image signal from an image source such as an external graphic apparatus. The input control signal can include a main clock signal, a vertical synchronizing signal, a horizontal synchronizing signal, and a data enable signal. The timing controller 120 can generate a data signal DATA which has a digital type and corresponds to operating conditions of the display panel 110 based at least in part on the input image signal. In addition, the timing controller 120 can generate a first control signal for controlling a driving timing of the scan driver 130, a second control signal for controlling a driving timing of the data driver 140, a third control signal for controlling the power controller 170 based at least in part on the input control signal. In some embodiments, the power controller 160 is included in the timing controller 120. In this case, the timing controller 120 can generate a control signal for controlling the power supply unit 150 and provide the control signal to the power supply unit 150.

The scan driver 130 can provide a scan signal to the display panel through a scan line. The scan driver 130 can output scan signals to the scan lines SL in each frame based at least in part on the first control signal. In some embodiments, the scan driver 130 is integrated in the display panel 110.

The data driver 140 can provide a data signal to the display panel through a data line based at least in part on the second control signal received from the timing controller 120. The data signal has one of a first logic level and a second logic level. The first logic level can be a logic high level and the second logic level can be a logic low level. Alternatively, the first logic level can be a logic low level and the second logic level can be a logic high level.

The power supply unit 150 can provide a first power voltage ELVDD and a second power voltage ELVSS respectively through first and second power lines. The power supply unit 150 can provide the second power voltage ELVSS having a first voltage level to the display panel 110 during an emission period such that the pixels 115 emit light, and provide the second power voltage ELVSS having a second voltage level higher than the first voltage level to the display panel 110 during a non-emission period such that the pixels 115 do not emit light.

In embodiments, the first power voltage ELVDD is a high potential DC voltage and the first voltage level of the second power voltage ELVSS is a low potential DC voltage lower than the first power voltage ELVDD. An OLED included in the pixel 115 can emit light based at least in part on a voltage difference between the first power voltage ELVDD and the second power voltage ELVSS.

The power supply unit 150 can provide the second power voltage ELVSS having the first or second voltage level by power controller 170. In some embodiments, the second voltage level of the second power voltage ELVSS can be substantially the same as a voltage level of the first power voltage ELVDD. In some embodiments, the second power voltage ELVSS having the second voltage level is provided to the display panel 110, a driving current does not flow in the pixel 115. Thus, in the digital driving technique, the second power voltage ELVSS has the second voltage level in the non-emission period. In some embodiments, when the OLED display is driven in a 3-dimensional image display mode, image data can be repeatedly outputted in 2 sub-frames to display one frame left-eye image or one frame right-eye image. One sub-frame period can correspond to the non-emission period and the other sub-frame period can correspond to the emission period. Thus, the power supply unit 150 can provide the second power voltage ELVSS having the second voltage level during the one sub-frame period corresponding to the non-emission period. The non-emission period can be generated when an abnormal operation of the display panel is detected, or substantially periodically generated.

The first sensing unit 160 can detect a second power line current flowing through the second power line during the non-emission period. In some embodiments, the first sensing unit 160 is driven based at least in part on a first detection control signal SS1 received from the power controller 160 or the timing controller 120.

When the display panel 110 is operating normally, the second power line current does not flow through the second power line during the non-emission period. Thus, the first sensing unit 160 cannot detect the second power line current when the display panel 110 is normally operated. However, if the display panel 110 is operating abnormally, the first sensing unit 160 can detect the second power line current. For example, the first sensing unit 160 detects an event of a short circuit in the display panel 110. Various factors can cause short circuit at power lines, which include not only internal, structural factors such as particles introduced into the display panel 110 during manufacturing process (or module process), cracks, defection of wiring layout, but also external factors such as static electricity. In addition, leakages by internal elements of the display panel 110 can generate the second power line current during the non-emission period. The first sensing unit 160 detects the second power line current such that the first sensing unit 160 can output a current detection signal DS1. The first sensing unit 160 can be implemented by using op-amps and switches. In some embodiments, the first sensing unit 160 further includes an analog-to-digital converter. At this time, the analog-to-digital converter converts an analog current value to a digital value.

The power controller 170 can control the power supply unit 150 to output the second power voltage ELVSS having the first voltage level or the second voltage level such that the non-emission period is determined. In some embodiments, the power controller 170 controls the power supply unit 150 based at least in part on the third control signal received from the timing controller 120.

In some embodiments, the power controller 170 sets the second power voltage ELVSS to have the second voltage level substantially periodically in each frame and sets the second power voltage ELVSS to have the first voltage level in other period in each frame. For example, a second voltage level period of the second power voltage ELVSS corresponds to the non-emission period of one frame. Thus, the first sensing unit 160 can detect a display panel defect substantially periodically.

The power controller 170 can turn off the power supply unit 150 based at least in part on the current detection signal DS1 outputted from the first sensing unit 160. In some embodiments, the power controller 170 outputs a shutdown signal SDS to turn off the power supply unit 150. The power supply unit 150 receiving the shutdown signal SDS can interrupt output voltages including the first power voltage ELVDD and the second power voltage ELVSS. The power controller 170 can be included in the timing controller 120.

The power controller 170 can set the second power voltage ELVSS to have the second voltage level in the emission period when currents and/or voltages applied to a certain line in the display panel 110 (e.g., the data line, the first power line, and/or the second power line) deviate from a normal range in the emission period. Thus, the power supply unit 150 can output the second power voltage ELVSS having the second level in a predetermined time. The abnormal current and/or the abnormal voltage can be detected by the second sensing unit 180 during the emission period.

In some embodiments, the second sensing unit 180 detects a voltage applied to the first power line or the second power line during the emission period. In some embodiments, the second sensing unit 180 is driven based at least in part on a second detection control signal SS2 received from the power controller 170. The voltage applied to the first power line or the second power line can be unintentionally changed (or fluctuated) caused by cracks of the display panel 110 or static electricity, etc. The voltage applied to the display panel can be unintentionally changed (or fluctuated) caused by an abnormal operation of the power supply unit 150. The second sensing unit 180 can detect the voltage change and output an abnormal detection signal DS2.

The second sensing unit 180 can compare the detected voltage with a predetermined reference voltage range, and output the abnormal detection signal DS2 when the detected voltage deviates from the reference voltage range. For example, if the voltage is to be applied to the first power line about 7V, the reference voltage range is set from about 6.7V to about 7.3V. The abnormal detection signal DS2 can be provided to the power controller 170. In some embodiments, the second sensing unit 180 is implemented by using op-amps and switches. In some embodiments, the second sensing unit 180 further includes an analog-to-digital converter. At this time, the analog-to-digital converter converts an analog value of the abnormal detection signal DS2 to a digital value.

The power controller 170 can control the power supply unit 150 to output the second power voltage ELVSS having the second voltage level during a predetermined duration in response to the abnormal detection signal DS2. For example, the second power voltage ELVSS has the second voltage level in about 0.2 ms when driving frequency is set to about 120 Hz. The first sensing unit 160 can operate during the predetermined duration (e.g., during about 0.2 ms). In other words, the first sensing unit 160 can detect the second power line current during the predetermined duration when the second sensing unit 180 outputs the abnormal detection signal DS2. As a result, the first sensing unit 160 can detect the display panel defect non-periodically. In some embodiments, the first sensing unit 160 outputs the current detection signal DS1 when the second power line current is detected. The current detection signal DS1 can be provide to the power controller 170.

The power controller 170 can turn off the power supply unit 150 based at least in part on the current detection signal DS1 applied from the first sensing unit 160. Thus, overheating of the display panel 110 and burning out of an internal element of the display panel 110 caused by overcurrent, etc., can be prevented. Further, it is possible to prevent additional damage from being caused by overheating, such as a fire.

In some embodiments, when the current detection signal DS1 is not provided to the power controller 170 that received the abnormal detection signal DS2, a failure occurrence message is displayed at the display panel 110.

In some embodiments, the power controller 170 generates a defect signal and provides the defect signal to the timing controller 120 when the second power line current is not detected. The timing controller 120 receiving the defect signal can generate an image data signal having failure occurrence message information based at least in part on the defect signal and provide the image data signal to the data driver 140. Thus, the display panel 110 can display the failure occurrence message based at least in part on the image data signal. In some embodiments, the OLED display 100 performs additional defect inspections to detect display panel defects or line defects based at least in part on the defect signal. The defect inspection method can be selected as any one of various methods currently known in the art.

In some embodiments, the power controller 170 controls the power supply unit 150 to output the second power voltage ELVSS having the second voltage level during a predetermined duration when a display mode is changed. After the predetermined duration, the second power voltage ELVSS can have the first voltage level again. For example, changing the display mode means turning on the OLED display 100, changing channels, converting from 2-dimensional image display mode to 3-dimensional image display mode, converting from 3-dimensional image display mode to 2-dimensional image display mode, changing predetermined modes such as sports view mode, animation view mode, etc. In this case, the second power voltage ELVSS having the second voltage level is provided to the display panel in the predetermined duration such that data of previous mode or previous frame (i.e., garbage data) can be removed during the predetermined duration. Thus, display noise from the garbage data can be prevented. Further, the first sensing unit 170 can detect abnormal operations of the display panel 110 in the predetermined duration.

As described above, the OLED display 100 driven by a digital driving technique of FIG. 1 can detect abnormal operations of the display panel 110 by switching (swinging) the voltage level of the second power voltage ELVSS substantially periodically or non-periodically, and turning off the power supply unit 150 when an abnormal operation is detected. Thus, overheating of the display panel 110 and burning out of an internal element of the display panel 110 caused by overcurrent, etc., can be prevented. Further, it is possible to prevent additional damage from being caused by overheating, such as a fire.

In addition, the OLED display 100 swings the voltage level of the second power voltage ELVSS so that display noise from the garbage data can be prevented.

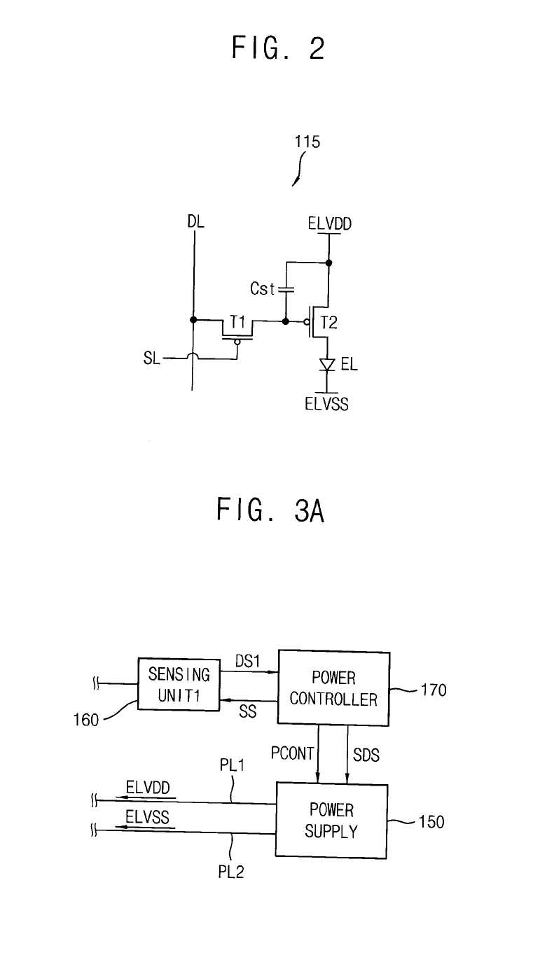

FIG. 2 is a circuit diagram illustrating an example of a pixel included in the OLED display of FIG. 1.

Referring to FIG. 2, the pixel 115 includes a first transistor T1, a second transistor T2, a storage capacitor Cst, and an OLED EL. The pixel 115 can be driven by a digital driving technique.

The first transistor T1 can be a switching transistor. The first transistor T1 can include a gate electrode electrically connected to a scan line SL, a first electrode electrically connected to a data line DL, and a second electrode electrically connected to a gate electrode of the second transistor T2. When a scan signal is provided to the scan line SL, the first transistor T1 can be turned on such that a data signal is transmitted to the gate electrode of the second transistor T2.

The second transistor T2 can include the gate electrode electrically connected to the second electrode of the first transistor T1, a first electrode to which a first power voltage ELVDD is applied, and a second electrode electrically connected to the anode of the OLED EL. The second transistor T2 can be a switching transistor, in the digital driving technique. The second transistor T2 can generate a driving current corresponding to a voltage difference between the gate electrode and the second electrode, and provide the driving current to the OLED EL.

The storage capacitor Cst can include a first terminal electrically connected to the first electrode of the second transistor T2, and a second terminal electrically connected to the gate electrode of the second transistor T2. The storage capacitor Cst can charge a voltage corresponding to an input data signal.

The anode of the OLED EL can be electrically connected to the second electrode of the second transistor T2. The cathode of the OLED EL can receive a second power voltage ELVSS. The OLED EL can emit light based at least in part on the driving current.

In some embodiments, the first power voltage ELVDD is a high potential DC voltage and the first voltage level of the second power voltage ELVSS is a low potential DC voltage lower than the first power voltage ELVDD. The second power voltage ELVSS can have a first voltage level or a second voltage level higher than the first voltage level. A power controller can control the voltage level of the second power voltage ELVSS. In some embodiments, the second voltage level of the second power voltage ELVSS is substantially the same as a voltage level of the first power voltage ELVDD. In some embodiments, when the second power voltage ELVSS having the second voltage level is provided to the display panel 110, the OLED EL does not emit light.

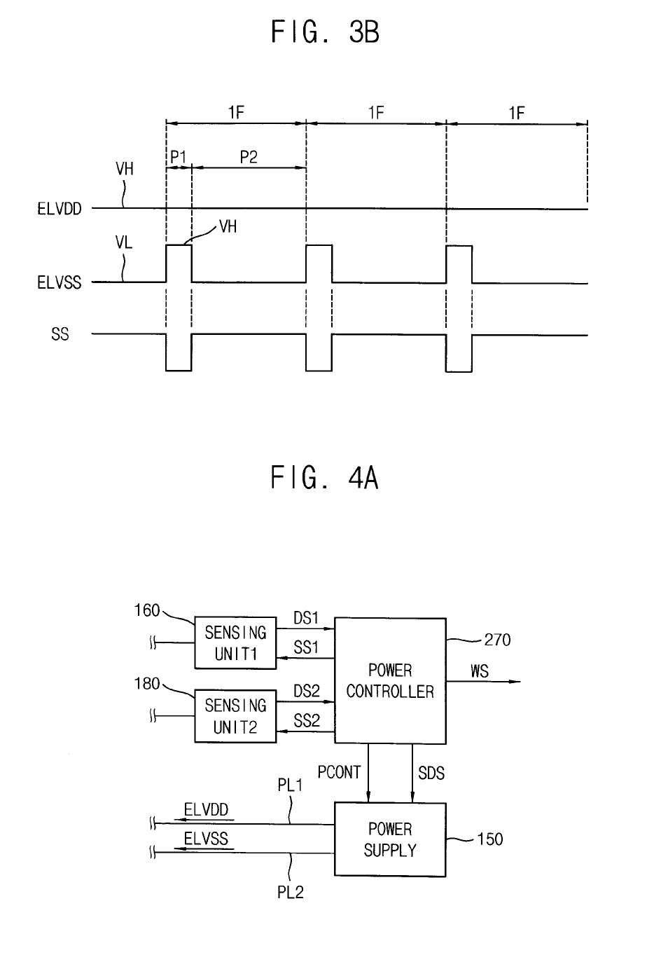

FIG. 3A is a block diagram illustrating an example of controlling a power supply unit included in the OLED display 100 of FIG. 1. FIG. 3B is a timing diagram illustrating an example of control operation the power supply unit of FIG. 3A.

Referring to FIGS. 1, 3A, and 3B, a circuit controlling the power supply unit 150 includes a first sensing unit 160 and a power controller 170. The power supply unit 150 can provide a first power voltage ELVDD and a second power voltage ELVSS to the display panel 110 respectively through a first power line PL1 and a second power line PL2.

The power controller 170 can provide a power control signal PCONT to the power supply unit 150 and control the power supply unit 150 to output the second power voltage ELVSS having a first voltage level VL or a second voltage level VH higher than the first voltage level VL. The power controller 170 can set the second power voltage ELVSS to have the second voltage level VH substantially periodically in each frame 1F and set the second power voltage ELVSS to have the first voltage level VL in the other period in each frame. For example, the second power voltage ELVSS has the second voltage level VH in about 0.2 ms when driving frequency is set to about 120 Hz. As illustrated in FIG. 3B, a first period P1 corresponds to an emission period outputting the second power voltage ELVSS having the second voltage level VH, and a second period P2 corresponds to a non-emission period outputting the second power voltage ELVSS having the first voltage level VL. In other words, the voltage level of the second power voltage ELVSS provided to the display panel 110 can be substantially periodically switched between the first voltage level VL and the second voltage level VH. However, a switching period is not limited thereto, and the second power voltage ELVSS can be intermittently switched in accordance with a predetermined period.

Current can flow from the first power line PL1 to the second power line PL2 based at least in part on a voltage difference between the first power voltage ELVDD and the second power voltage ELVSS in the second period P2 so that the OLED can emit light.

The power controller 170 can provide a detection control signal SS to the first sensing unit 160 during the first period P1. The first sensing unit 160 can detect a second power line current flowing through the second power line PL2. The power controller 170 can control the power supply unit 150 to output the second power voltage ELVSS having the second voltage level VH, and at substantially the same time, control the first sensing unit 160 to detect the second power line current.

The first sensing unit 160 can detect the second power line current flowing through the second power line PL2. The first sensing unit 160 can detect the second power line current whenever the power supply unit 150 outputs the second power voltage ELVSS having the second voltage level VH. In other words, as illustrated in FIGS. 3A and 3B, the first sensing unit 160 detects a display panel defect substantially periodically.

The first sensing unit 160 can output a current detection signal DS1 when the second power line current is detected. The current detection signal DS1 can be provided to the power controller 170. In some embodiments, the first sensing unit 160 is implemented by using op-amps and switches. The first sensing unit 160 can further include an analog-to-digital converter. At this time, the analog-to-digital converter converts an analog value of the current detection signal DS1 to a digital value. A reference value for generating the current detection signal DS1 is not limited to about OA. The reference value can be changed, for example, by a manufacturing company based at least in part on the size, purpose, and environment and can be from about 0 mA to several mA. In this case, the first sensing unit 160 can generate the current detection signal DS1 when the second power line current exceeds a predetermined reference value from about 0 mA to several mA.

The power controller 170 can turn off the power supply unit 150 based at least in part on the current detection signal DS1. Thus, the power supply unit 150 can interrupt output voltages including the first power voltage ELVDD and the second power voltage ELVSS. In some embodiments, the power controller 170 outputs a shutdown signal SDS to turn off the power supply unit 150. Therefore, overheating of the display panel 110 and burning out of an internal element of the display panel 110 caused by overcurrent, etc., can be prevented.

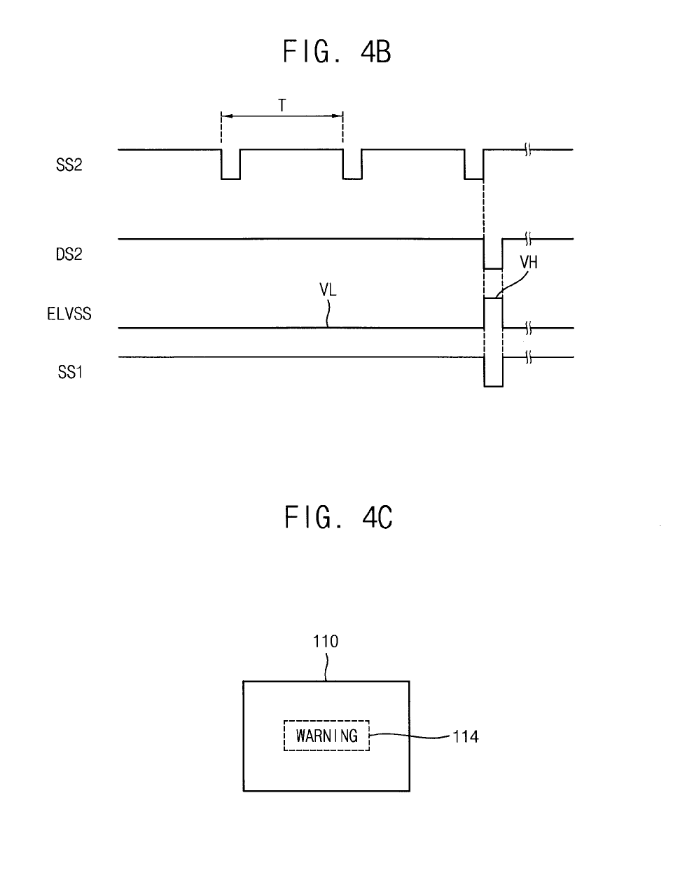

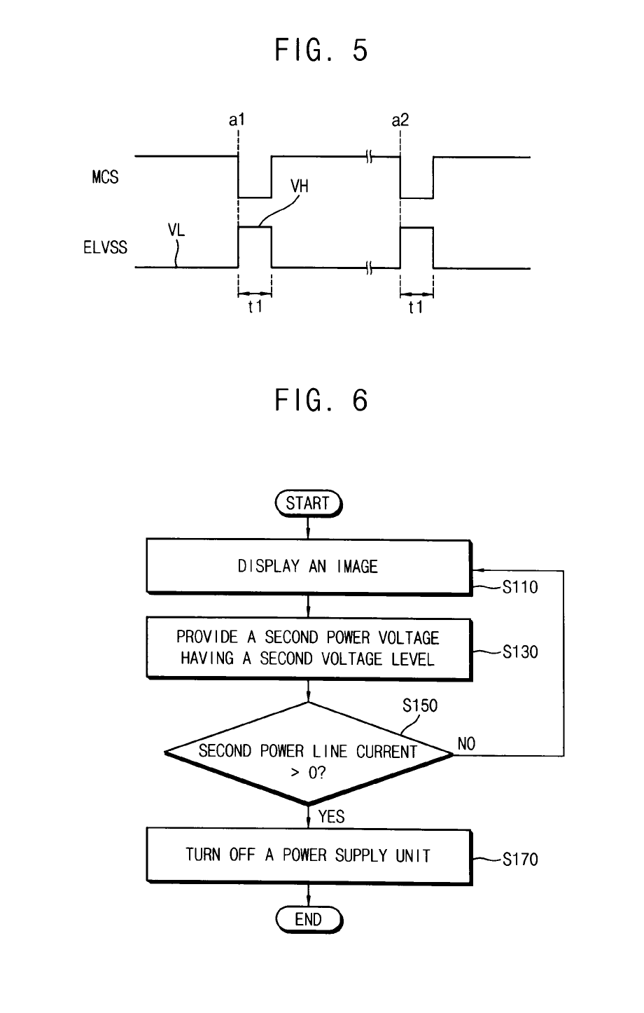

FIG. 4A is a block diagram illustrating another example of controlling a power supply unit included in the OLED display 100 of FIG. 1. FIG. 4B is a timing diagram illustrating an example of control operation a power controller of FIG. 4A. FIG. 4C is a diagram illustrating an example of a display panel displaying a message by operation of the power controller of FIG. 4A.

Referring to FIGS. 1, 4A, 4B, and 4C, a circuit controlling the power supply unit 150 includes a first sensing unit 160, a second sensing unit 180, and a power controller 270.

As illustrated in FIGS. 4 and 4B, the power controller 270 outputs a first detection control signal SS1, a second detection control signal SS2 and a shutdown signal SDS. The first sensing unit 160 can output a current detection signal DS1, and the second sensing unit 180 can output an abnormal detection signal DS2 The power controller 270 can further output a power control signal PCONT to the power supply unit 150. The power supply unit 150 can provide the first power voltage ELVDD and the second power voltage ELVSS to the display panel 110 based at least in part on operation of the power controller 270.

The power supply unit 150 can provide the first power voltage ELVDD and the second power voltage ELVSS to the display panel 110 respectively through the first power line PL1 and the second power line PL2. The second power voltage ELVSS can have a first voltage level VL or a second voltage level VH higher than the first voltage level VL.

In some embodiments, the second sensing unit 180 substantially periodically detects a voltage applied to the first power line PL1 or the second power line PL2 while the second power voltage ELVSS having the first voltage level VL is outputted (i.e., during the emission period). In some embodiments, the second sensing unit 180 substantially periodically receives a second detection control signal SS2 from the power controller 270. The second sensing unit 180 can substantially periodically detect the voltage applied to the first power line PL1 or the second power line PL2 based at least in part on the second detection control signal SS2.

In some embodiments, the second sensing unit 180 is electrically connected to the first power line PL1 to detect the voltage applied to the first power line PL1 or electrically connected to the second power line PL2 to detect the voltage applied to the second power line PL2. In some embodiments, the second sensing unit 180 is electrically connected to the first power line PL1 and the second power line PL2 to detect the voltage applied to the first power line PL1 and the second power line PL2. The second sensing unit 180 can further include an analog-to-digital converter. At this time, the analog-to-digital converter converts an analog value of the abnormal detection signal DS2 to a digital value. However, the voltage detected from the second sensing unit 180 is not limited thereto. For example, the second sensing unit 180 detects abnormalities of a voltage applied to the data line DL.

The second sensing unit 180 can compare a detected voltage detected by the second sensing unit 180 with a predetermined reference voltage range. The second sensing unit 180 can output the abnormal detection signal DS2 when the detected voltage deviates from the reference voltage range. For example, if the voltage to be applied to the first power line is about 7V, the reference voltage range is set from about 6.7V to about 7.3V. The abnormal detection signal DS2 can be provided to the power controller 270.

In some embodiments, the second sensing unit 180 substantially periodically detects a current applied to the first power line PL1 or the second power line PL2 in response to the second detection control signal SS2.

The second sensing unit 180 can be electrically connected to the first power line PL1 to detect the current applied to the first power line PL1 or electrically connected to the second power line PL2 to detect the current applied to the second power line PL2. However, the current detected from the second sensing unit 180 is not limited thereto. For example, the second sensing unit 180 detects abnormalities of a current applied to the data line DL.

The second sensing unit 180 can compare a detected current detected by the second sensing unit 180 with a predetermined reference current range. The second sensing unit 180 can output the abnormal detection signal DS2 when the detected current deviates from the reference current range. The abnormal detection signal DS2 can be provided to the power controller 270.

The power controller 270 can control the power supply unit 150 to output the second power voltage ELVSS having the second voltage level VH based at least in part on the abnormal detection signal DS2. In addition, the power controller 270 can provide the first detection control signal SS1 to the first sensing unit 160 based at least in part on the abnormal detection signal DS2. The first sensing unit 160 can detect the second power line current in response to the first detection control signal SS1. The power controller 270 can control the power supply unit 150 to output the second power voltage ELVSS having the second voltage level VH and at substantially the same time control the first sensing unit 160 to detect the second power line current.

The first sensing unit 160 can detect the second power line current when the second power voltage ELVSS has the second voltage level VH. In some embodiments, the first sensing unit 160 detects the second power line current when the second sensing unit 180 outputs the abnormal detection signal DS2.

The first sensing unit 160 can output the current detection signal DS1 when the second power line current is detected. The current detection signal DS1 can be provided to the power controller 270. A reference value for generating the current detection signal DS1 is not limited to about 0 A. The reference value can be changed, for example, by a manufacturing company based at least in part on the size, purpose, and environment and can be from about 0 mA to several mA. In this case, the first sensing unit 160 can generate the current detection signal DS1 when the second power line current exceeds a predetermined reference value from about 0 mA to several mA.

In some embodiments, the power controller 270 turns off the power supply unit 150 based at least in part on the current detection signal DS1. Thus, the power supply unit 150 can interrupt output voltages including the first power voltage ELVDD and the second power voltage ELVSS. Therefore, overheating of the display panel 110 and burning out of an internal element of the display panel 110 caused by overcurrent, etc., can be prevented.

The display panel 110 can display a failure occurrence message 114 when the current detection signal DS1 is not provided to the power controller 270.

In some embodiments, the power controller 270 generates a defect signal WS and provides the defect signal to the timing controller 120 when the second power line current is not detected. The display panel 110 can display the failure occurrence message 114 when the abnormal detection signal DS2 has been outputted but the second power line current is not detected.

As illustrated in FIG. 4C, the timing controller 120 generates an image data signal having failure occurrence message information in response to the defect signal WS. The display panel 110 can display the failure occurrence message 114 based at least in part on the image data signal. In some embodiments, the OLED display 100 performs additional defect inspections to detect display panel defects or line defects based at least in part on the defect signal WS.

As described above, the OLED display 100 driven by a digital driving technique of FIGS. 4A to 4C can detect abnormal operations of the display panel 110 by switching (swinging) the voltage level of the second power voltage ELVSS non-periodically. The OLED display 100 can turn off the power supply unit 150 or display the failure occurrence message 114 based at least in part on the detect operation so that overheating of the display panel 110 and burning out of an internal element of the display panel 110 can be prevented.

FIG. 5 is a timing diagram illustrating still another example of controlling a power supply unit included in the OLED display 100 of FIG. 1.

Referring to FIGS. 1 and 5, the power controller 170 controls the second power voltage ELVSS outputted from the power supply unit 150.

In some embodiments, the power controller 170 controls the power supply unit 150 to output the second power voltage ELVSS having the second voltage level VH for a predetermined duration and output the second power voltage ELVSS having the first voltage level VL after the predetermined duration when a display mode is changed (i.e., at a time point a1 and a time point a2 of FIG. 5).

For example, changing the display mode means turning on the OLED display 100, changing channels, converting from 2-dimensional image display mode to 3-dimensional image display mode, converting from 3-dimensional image display mode to 2-dimensional image display mode, changing predetermined modes such as sports view mode, animation view mode, etc.

In some embodiments, the power controller 170 provides a convert signal MCS to the power supply unit 150 when the display mode is changed. The power supply unit 150 can provide the second power voltage ELVSS having the second voltage level VH to the display panel 110 during a certain period t1 (i.e., during the predetermined duration). Thus, data of previous mode or previous frame (i.e., garbage data) can be removed during the period t1 such that display noise from the garbage data can be prevented.

In some embodiments, the first sensing unit 170 detects the second power line current during the period t1. As a result, abnormal operations of the display panel 110 can be detected.

FIG. 6 is a flowchart of a method of driving an OLED display according to example embodiments.

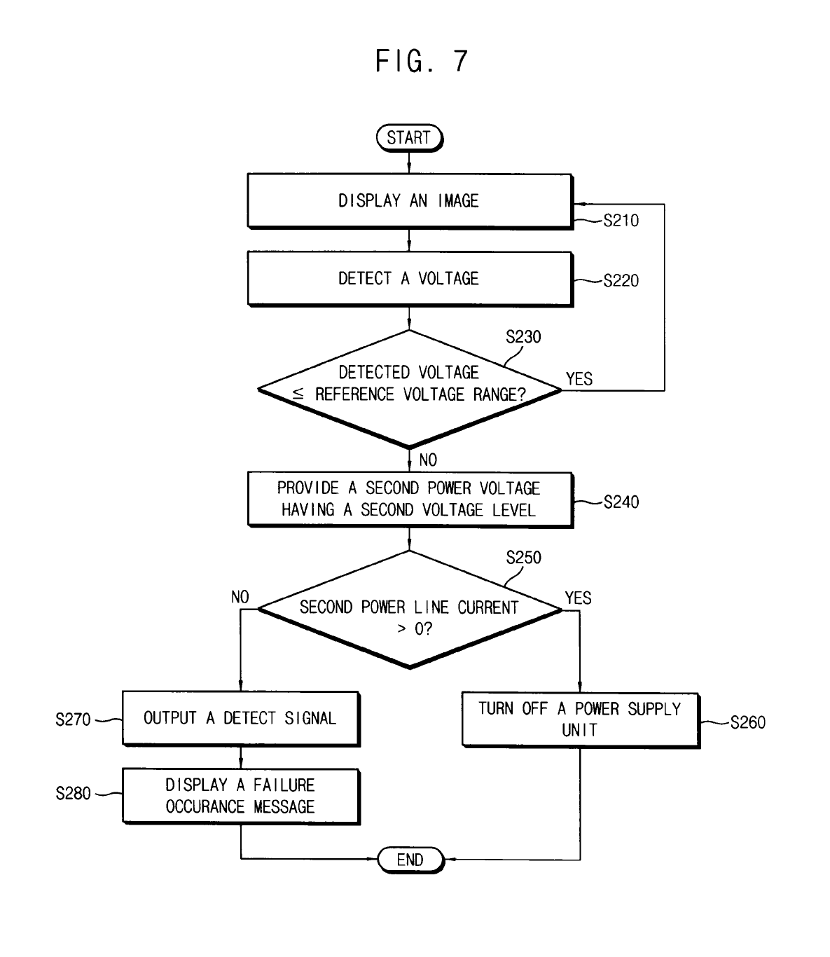

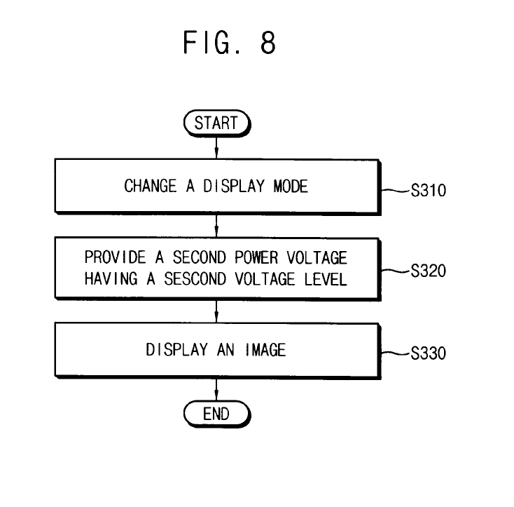

In some embodiments, the FIG. 6 procedure is implemented in a conventional programming language, such as C or C++ or another suitable programming language. The program can be stored on a computer accessible storage medium of the OLED display 100, for example, a memory (not shown) of the OLED display 100 or the timing controller 120. In certain embodiments, the storage medium includes a random access memory (RAM), hard disks, floppy disks, digital video devices, compact discs, video discs, and/or other optical storage mediums, etc. The program can be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 8/7/Vista/2000/9x/ME/XP, Macintosh OS, OS X, OS/2, Android, iOS and the like. In another embodiment, at least part of the procedure can be implemented with embedded software. Depending on the embodiment, additional states can be added, others removed, or the order of the states changed in FIG. 6. The description of this paragraph applies to the embodiments shown in FIGS. 7-8.

Referring to FIG. 6, the method of driving the OLED display includes displaying an image on a display panel (S110) and providing the second power voltage having a second voltage level higher than the first voltage level to the display panel through the second power line (S130). The method also includes detecting a second power line current flowing through the second power line when the second power voltage has the second voltage level (S150) and turning off a power supply unit providing the first power voltage and the second power voltage to the display panel when the second power line current is detected (S170). The OLED display is driven by a digital driving technique. In what follows, the method of driving the OLED display according to one example embodiment will be described with reference to FIGS. 1 to 5. However, the driving method of FIG. 6 only represents methods utilizing one or more configurations described earlier but is not limited to the description.

The OLED display 100 can display an image on the display panel 110 based at least in part on the first power voltage ELVDD provided through the first power line PL1, and the second power voltage ELVSS provided to a second power line ELVSS having a first voltage level VL provided through a second power line (S110). In some embodiments, the OLED display 100 is driven by the digital driving technique.

The second power voltage ELVSS having a second voltage level VH higher than the first voltage level VL can be provided to the display panel 110 through the second power line PL2 (S130). The second power voltage ELVSS having a second voltage level VH can be provided to the display panel 110 substantially periodically or non-periodically. In some embodiments, the second power voltage ELVSS having a second voltage level VH is provided to the display panel 110 during a non-emission period of each frame. The second voltage level VH of the second power voltage ELVSS can be substantially the same as a voltage level of the first power voltage ELVDD.

The first sensing unit 160 can detect the second power line current flowing through the second power line PL2 when the second power voltage ELVSS has the second voltage level VH S150. In some embodiments, when the display panel 110 is operating normally, the second power line current does not flow through the second power line PL2 during the non-emission period. Thus, in some embodiments, the first sensing unit 160 does not detect the second power line current when the display panel 110 is operating normally. In contrast, when the display panel 110 is operating abnormally, the first sensing unit 160 can detect the second power line current and output the current detection signal DS1 to the power controller 170.

The power controller 170 can turn off the power supply unit 150 (S170). Since driving the OLED display 100 is described above referred to FIGS. 1 to 5, duplicate descriptions will not be repeated.

FIG. 7 is a flowchart illustrating an example of an operation of the OLED display 100 of FIG. 6 that detects abnormal operations.

Referring to FIGS. 1 to 7, the method of driving the OLED display non-periodically outputs the second power voltage ELVSS having the second voltage level VH. Thus, detecting the second power line current is non-periodically performed.

The method of driving the OLED display includes displaying an image (S210), detecting a voltage applied to the first power line PL1 or the second power line PL2 (S220), and comparing the detected voltage with a predetermined reference voltage range while the image is displayed (S230). The second sensing unit 180 can detect the voltage applied to the first power line PL1 or the second power line PL2 and compare the detected voltage with the reference voltage range.

When the detected voltage is in the reference voltage range, the display panel 110 can display the image.

When the detected voltage deviates from the reference voltage range, the second power voltage ELVSS having the second voltage level VH can be provided to the display panel 110 (S240). Further, the first sensing unit 160 can detect the second power line current S250 when the second power voltage ELVSS having the second voltage level VH is provided to the display panel 110 (S240).

The power supply unit 150 can be turned off (S260) when the second power line current is detected. In some embodiments, the first sensing unit 160 outputs the current detection signal DS1 when the second power line current is detected. The current detection signal DS1 can be provided to the power controller 170. In some embodiments, the power controller 170 outputs the shutdown signal SDS to the power supply unit 150 based at least in part on the current detection signal DS1.

The defect signal WS can be outputted (S270) from the power controller 170 when the detected voltage deviates from the reference voltage range but the second power line current is not detected. Then, the failure occurrence message 114 can be displayed (S280) on the display panel 110 based at least in part on the defect signal WS.

As described above, the method of driving the OLED display 100 of FIGS. 6 and 7 can detect abnormal operations of the display panel 110 by switching (swinging) the voltage level of the second power voltage ELVSS substantially periodically and non-periodically. The method can turn off the power supply unit 150 or display the failure occurrence message 114 when an abnormal operation of the display panel 110 is detected. Thus, overheating of the display panel 110 and burning out of an internal element of the display panel 110 can be prevented. In addition, it is possible to prevent additional damage from being caused by overheating, such as a fire.

FIG. 8 is a flowchart illustrating an example of operation of the OLED display 100 of FIG. 6 when a display mode is changed.

Referring to FIGS. 1, 5 and 8, the second power voltage ELVSS having the second voltage level VH is provided to the display panel 110 in a predetermined duration (S320) when a display mode is changed (S310). After the predetermined duration, the display panel 110 can display an image (S330) based at least in part on receiving the data signal from the data driver. After the predetermined duration, the second power voltage ELVSS can have the first voltage level VL again.

For example, changing the display mode means turning on the OLED display 100, changing channels, converting from 2-dimensional image display mode to 3-dimensional image display mode, converting from 3-dimensional image display mode to 2-dimensional image display mode, changing predetermined modes such as sports view mode, animation view mode, etc.

The second power voltage ELVSS having the second voltage level VH can provide to the display panel 100 (S320) when the display mode is changed (S310). In this case, data of previous mode or previous frame (i.e., garbage data) can be removed during the predetermined duration. Thus, display noise from the garbage data can be prevented. Further, the first sensing unit 170 can detect abnormal operations of the display panel 110 during the predetermined duration.

After the predetermined duration, the second power voltage ELVSS can have the first voltage level VL, and the display panel 110 can display the image (S330). Since driving the OLED display 100 is described above referred to FIGS. 1 to 7, duplicate descriptions will not be repeated.

The present embodiments can be applied to any display device and any system including the display device. For example, the present embodiments are applied to display devices such as liquid crystal displays (LCDs), organic light-emitting diode (OLED) displays, plasma display panels (PDPs), etc., and applied to televisions, computer monitors, laptops, digital cameras, cellular phones, smartphones, smart pads, personal digital assistants (PDAs), portable multimedia players (PMPs), MP3 players, navigation systems, game consoles, video phones, etc.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The inventive technology is defined by the following claims, with equivalents of the claims to be included therein.

What is claimed is:

1. An organic light-emitting diode (OLED) display driven by a digital driving technique, comprising:
a display panel including a plurality of pixels;
a scan driver configured to provide a scan signal to the display panel through a scan line;
a data driver configured to provide a data signal to the display panel through a data line, wherein the data signal has one of first and second logic levels;
a power supply unit configured to provide first and second power voltages respectively through first and second power lines so as to i) transmit the second power voltage having a first voltage level to the display panel during an emission period such that the pixels emit light and ii) transmit the second power voltage having a second voltage level higher than the first voltage level to the display panel during a non-emission period such that the pixels do not emit light;
a first sensor configured to detect a second power line current flowing through the second power line during the non-emission period;
a power controller configured to determine the non-emission period and turn off the power supply unit based at least in part on a current detection signal output from the first sensor; and
a timing controller configured to control the scan driver, the data driver, the power supply unit and the power controller,
wherein the non-emission period is substantially periodic or corresponds to when an abnormal operation of the display panel is detected.

2. The device of claim 1, further comprising a second sensor configured to detect a voltage applied to the first power line or the second power line during the emission period.

3. The device of claim 2, wherein the second sensor is further configured to i) determine whether the detected voltage is within a predetermined reference voltage range and ii) output an abnormal detection signal when the detected voltage is not within the reference voltage range.

4. The device of claim 3, wherein the power controller is further configured to control the power supply unit so as to output the second power voltage having the second voltage level during a predetermined duration based at least in part on the abnormal detection signal.

5. The device of claim 4, wherein the first sensor is further configured to detect the second power line current during the predetermined duration.

6. The device of claim 5, wherein the power controller is further configured to i) generate a defect signal and ii) provide the defect signal to the timing controller when the second power line current is not detected.

7. The device of claim 6, wherein the timing controller is further configured to generate an image data signal having failure occurrence message information based at least in part on the defect signal, and wherein the display panel is configured to display a failure occurrence message based at least in part on the image data signal.

8. The device of claim 1, further comprising a second sensor configured to detect a current applied to the first or second power line during the emission period.

9. The device of claim 8, wherein the second sensor is further configured to i) determine whether the detected current is within a predetermined reference current range and ii) output an abnormal detection signal when the detected current is not within the reference current range.

10. The device of claim 9, wherein the power controller is further configured to control the power supply unit so as to output the second power voltage having the second voltage level during a predetermined duration based at least in part on the abnormal detection signal.

11. The device of claim 10, wherein the first sensor is further configured to detect the second power line current during the predetermined duration.

12. The device of claim 11, wherein the power controller is further configured to i) generate a defect signal and ii) provide the defect signal to the timing controller when the second power line current is not detected.

13. The device of claim 12, wherein the timing controller is further configured to generate an image data signal having failure occurrence message information based at least in part on the defect signal, and wherein the display panel is configured to display a failure occurrence message based at least in part on the image data signal.

14. The device of claim 1, wherein the power controller is further configured to control the power supply unit to i) output the second power voltage having the second voltage level during a predetermined duration and ii) output the second power voltage having the first voltage level after the predetermined duration when a display mode is changed.

15. The device of claim 14, wherein the first sensor is further configured to detect the second power line current during the predetermined duration.

16. A method of driving an organic light-emitting diode (OLED) display by a digital driving technique, comprising:
displaying an image on a display panel based at least in part on i) a first power voltage provided through a first power line and ii) a second power voltage having a first voltage level provided through a second power line, wherein the display panel is configured to receive the first and second power voltages from a power supply unit;
providing the second power voltage having a second voltage level higher than the first voltage level to the display panel through the second power line;
detecting a second power line current flowing through the second power line when the second power voltage has the second voltage level; and
turning off the power supply unit when the second power line current is detected.

17. The method of claim 16, wherein the providing includes:
detecting a voltage applied to the first or second power line;
determining whether the detected voltage is within a predetermined reference voltage range; and
providing the second power voltage having the second voltage level to the display panel when the detected voltage is not within the reference voltage range.

18. The method of claim 17, further comprising:
outputting a defect signal when the detected voltage is not within the reference voltage range and the second power line current is not detected; and
displaying a failure occurrence message on the display panel based at least in part on the defect signal.

19. The method of claim 16, wherein the second voltage level of the second power voltage is substantially periodically provided to the display panel through the second power line.

20. The method of claim 16, further comprising providing the second power voltage having the second voltage level to the display panel during a predetermined duration when a display mode is changed.
